(19) United States
(12) Patent Application Publication
(10) Pub. No.: US 2010/0206842 A1
(43) Pub. Date: Aug. 19, 2010

(54) Novel Method Of Air Gap Pattern For Advanced Back End Of Line (BOEL) Interconnect

(75) Inventor: Shiqun Gu, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/372,942

(22) Filed: Feb. 18, 2009

(51) Int. Cl. B44C 1/22

(52) U.S. Cl. 216/41

(57) ABSTRACT

An air gap pattern is created for backend of line (BEOL) interconnects. The method includes designing a nano-island pattern, and etching through the designed nano-island pattern to create at least one air gap between wire connects.

### TECHNICAL FIELD

The present disclosure generally relates to semiconductor fabrication. More specifically, the present disclosure relates to the methods of fabricating integrated circuits with reduced parasitic capacitance.

### BACKGROUND

As integrated circuits become smaller, with a corresponding increase in device density, the size and spacing of wire interconnects between circuit components becomes less. One result of the decrease in size and spacing is an increase in circuit signal delay (or “RC delay”) due to increased resistance and enhanced parasitic capacitance effects of closely-spaced wire interconnects. One way of reducing the circuit signal delay is to decrease the parasitic capacitance of the integrated circuit by embedding wire interconnects in a material of lower dielectric constant.

For example, in a previous method, a space or “air gap” is created in the interlayer dielectric between wire interconnects. The space is filled with air or exists as a vacuum. The low dielectric constant of the air or vacuum (k=1) reduces the parasitic capacitance of the circuit, thus reducing signal delay. In this method, self-assembling nanowires produce a material having a pattern of nanoscale-sized holes, and the pattern of holes is used as a guide to create air gaps in the interlayer dielectric. Because the pattern of holes is formed by self-assembling nanowires, however, the pattern is not designed to match the underlying pattern of the wire interconnects. In addition, the uniformity of the nanowire self-assembly process is difficult to regulate. To provide greater control over air gap formation, a method of creating air gaps in the interlayer dielectric using a designed pattern of nanoscale-sized holes is desirable.

### BRIEF SUMMARY

In one aspect, a method for creating an air gap pattern for backend of line (“BOEL”) interconnects is provided. The method includes preparing a designed nano-island pattern, and etching through the designed nano-island pattern to create at least one air gap between the BEOL interconnects.

In another aspect, a method for creating an air gap pattern for BOEL interconnects includes designing a nano-island pattern using photolithography, and preparing the designed nano-island pattern in a layer of dielectric material located above a metal layer. The metal layer includes the BEOL interconnects. The method includes etching through the designed nano-island pattern to create at least one air gap between the BEOL interconnects.

In a further aspect, a method for creating an air gap pattern for BOEL interconnects includes designing a nano-island pattern, and preparing the designed nano-island pattern from a layer of dielectric material located above a metal layer, the metal layer including the BEOL interconnects. The method includes adding an etch stop layer above the designed nano-island pattern, and polishing the etch stop layer to expose the designed nano-island pattern. Additionally, the method includes etching through the designed nano-island pattern to create at least one air gap between the BEOL interconnects.

In these methods, the nano-island pattern is not restricted to a single given pattern, but can be designed and varied according to the pattern of wire interconnects. In addition, the nano-island pattern can vary depending on differences in metal density of the metal layer, which can “tune” the depth of the air gap to the metal density. For example smaller holes in the pattern can create shallower gaps.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure, reference is now made to the following description taken in conjunction with the accompanying drawings.

FIG. 1 is a block diagram showing an exemplary wireless communication system in which an embodiment of the disclosure may be advantageously employed.

FIGS. 2A-2G are schematic drawings illustrating a method of creating air gaps.

FIGS. 3A-3I are schematic drawings illustrating a method of creating air gaps using a designed pattern of holes.

### DETAILED DESCRIPTION

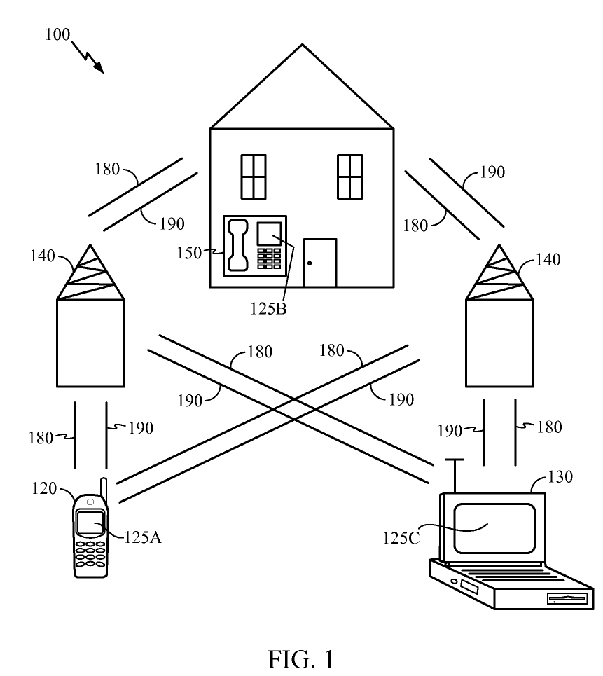

FIG. 1 shows an exemplary wireless communication system 100 in which an embodiment of the disclosure may be advantageously employed. For purposes of illustration, FIG. 1 shows three remote units 120, 130, and 150 and two base stations 140. It will be recognized that typical wireless communication systems may have many more remote units and base stations. Remote units 120, 130, and 150 include improved semiconductor chips 125A, 125B, and 125C, respectively, which are embodiments as discussed further below. FIG. 1 shows forward link signals 180 from the base stations 140 and the remote units 120, 130, and 150 and reverse link signals 190 from the remote units 120, 130, and 150 to base stations 140.

In FIG. 1, remote unit 120 is shown as a mobile telephone, remote unit 130 is shown as a portable computer, and remote unit 150 is shown as a fixed location remote unit in a wireless local loop system. For example, the remote units may be cell phones, hand-held personal communication systems (PCS) units, portable data units such as personal data assistants, or fixed location data units such as meter reading equipment. Although FIG. 1 illustrates remote units according to the teachings of the disclosure, the disclosure is not limited to these exemplary illustrated units. The disclosure may be suitably employed in any device which includes a semiconductor chip.

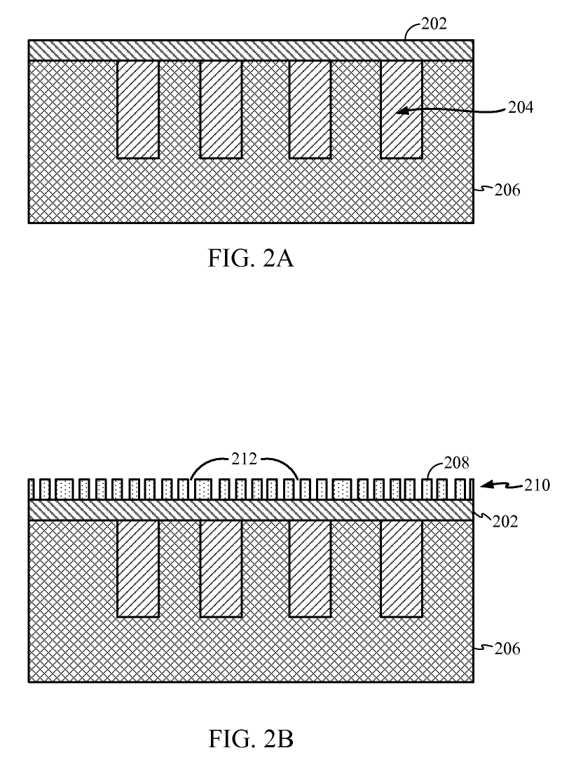

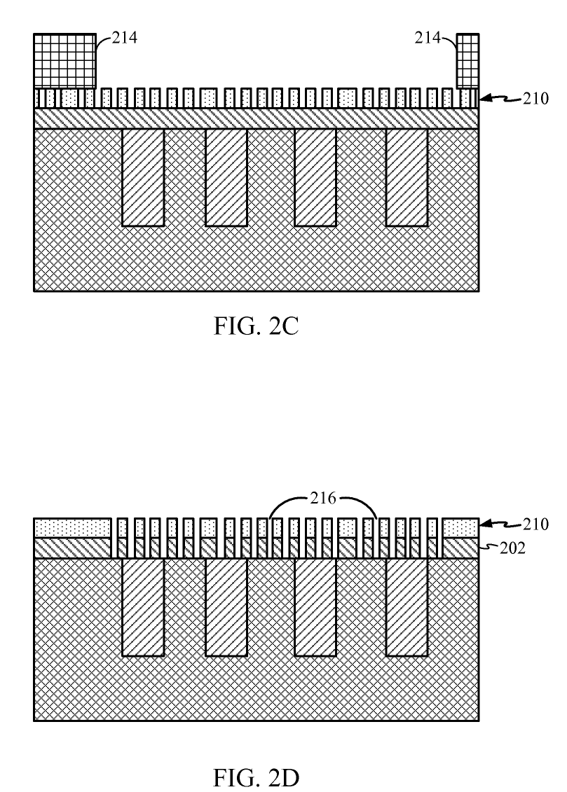

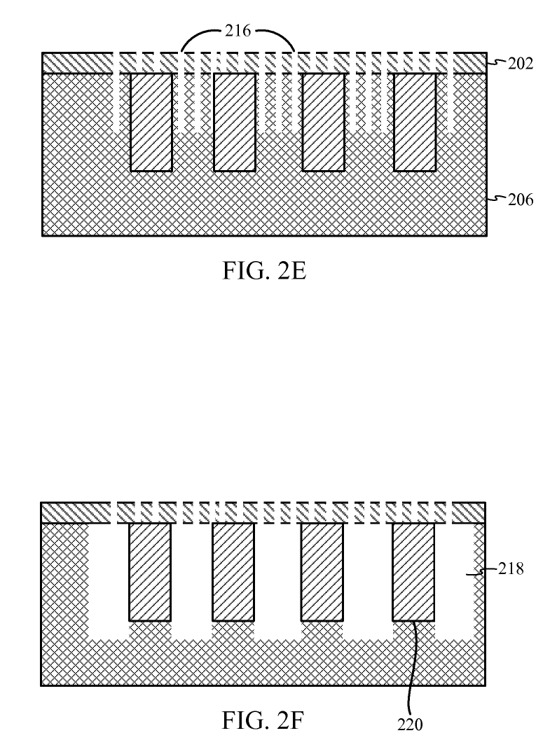

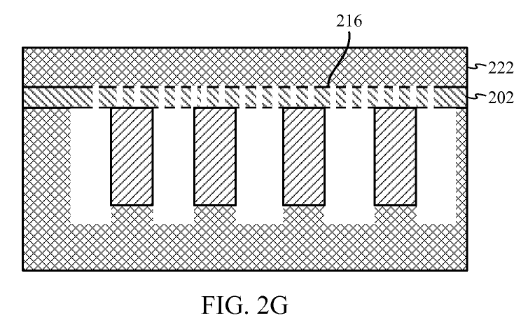

A previous method of creating air gaps, using self-assembling nanowires (such as a protein), is depicted in FIGS. 2A-2G. As shown in FIG. 2A, an etch stop layer 202 is deposited over a metal layer 204 embedded in an interlayer dielectric 206. Self-assembling nanowires 208 are then deposited over the etch stop layer 202, as depicted in FIG. 2B. The self-assembling nanowires 208 form a nanowire layer 210 having small, nanoscale-sized holes 212 arranged in a regular pattern. Next, as depicted in FIG. 2C, a mask 214 is prepared over the nanowire layer 210 to act as a barrier, leaving exposed areas of the nanowire layer 210. The pattern of nanoscale-sized holes 212 in the exposed nanowire layer 210 is then translated into the etch stop layer 202, resulting in a pattern of holes 216 in the etch stop layer 202, as depicted in FIG. 2D. The nanowire layer 210 is removed and the holes 216 in the etch stop layer 202 are extended into the interlayer dielectric 206 (FIG. 2E) and air gaps 218 between metal wires 220 of the metal layer 204 are formed (FIG. 2F). A chemical vapor deposition (“CVD”) process deposits a dielectric layer 222 to cap the holes 216 in the etch stop layer 202, as shown in FIG. 2G.

The self-assembling nanowires arrange themselves in a honeycomb-like structure to form a pattern of holes. Because the holes are derived from a self-assembly process, the pattern of holes is not designed to vary in accordance with variations in the underlying metal layer.

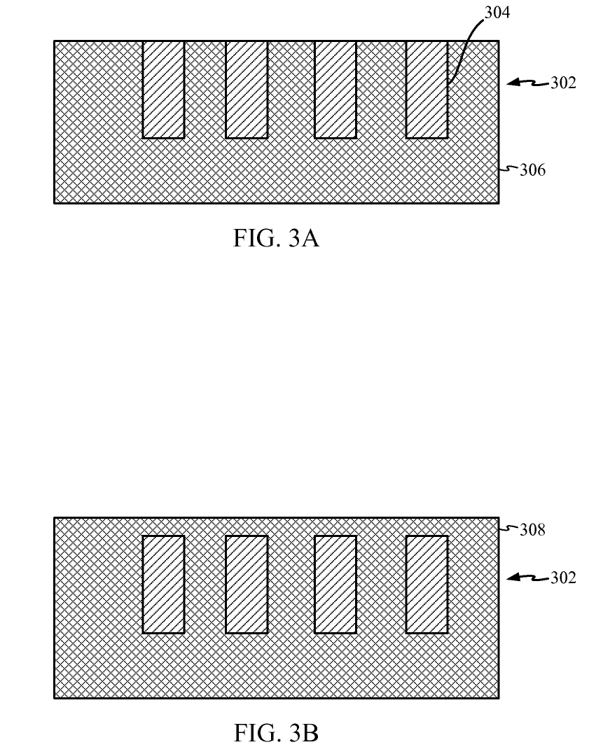

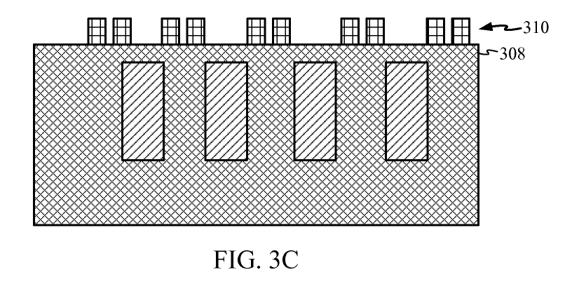

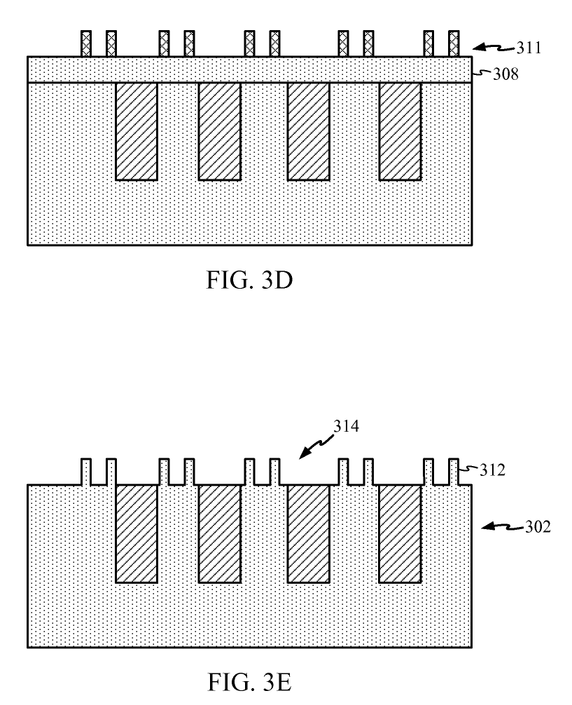

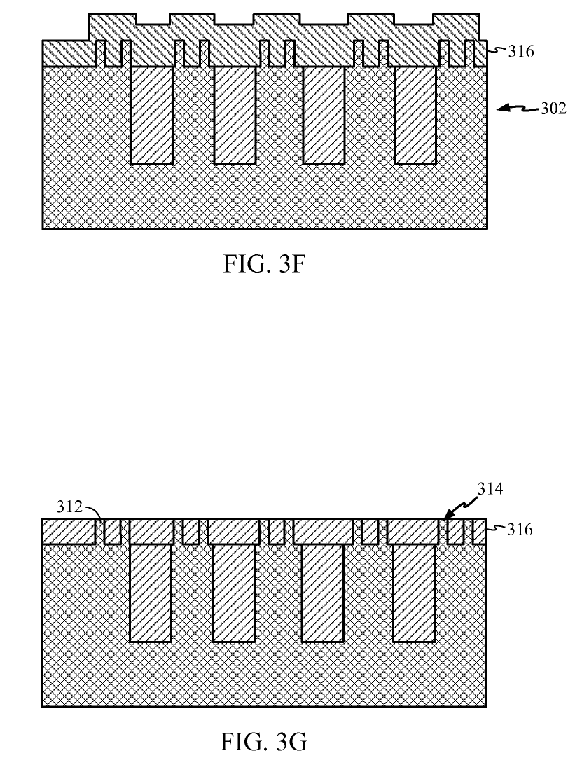

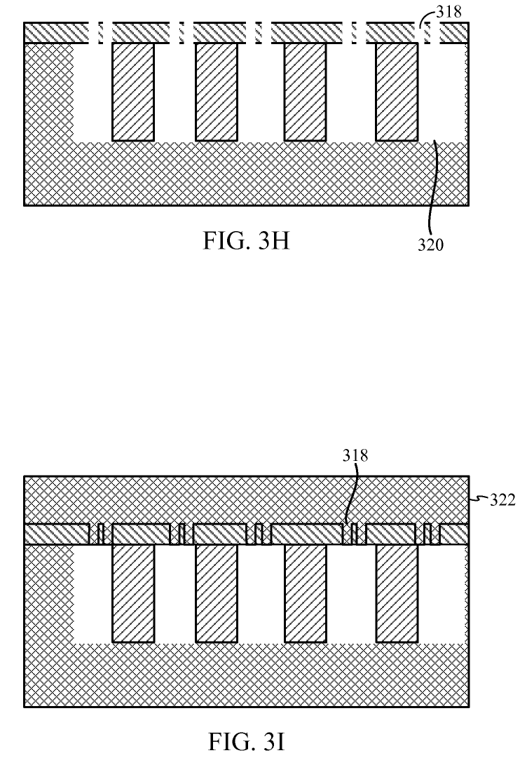

As described herein, a method of creating air gaps is provided in which the pattern of holes designed. An overview of the method is provided in FIGS. 3A-3I. A cross-sectional view of a metal layer 302 is depicted in FIG. 3A. The metal layer 302 contains metal wires 304 embedded in an interlayer dielectric 306. For ease of view, only the metal layer 302 is shown, but it should be understood that the metal layer 302 is fabricated over a built-up integrated circuit which includes a substrate and semiconductor devices, and can include one or more layers such as an antireflective coating layer, liner oxide layer, barrier layer, metal layer, or any combination or number of layers thereof.

Referring to FIGS. 3B-3F, a thin layer 308 of interlayer dielectric is deposited over the metal layer 302. Next, a patterned photoresist 310 is prepared over the thin interlayer dielectric layer 308. The patterned photoresist 310 is trimmed to sub-resolution dimensions to produce a trimmed photoresist pattern 311, then the thin interlayer dielectric layer 308 is etched to produce nanoscale islands 312, or “nano-islands,” of dielectric material. The nano-islands 312 form a nano-island pattern 314 above the metal layer 302. Next, an etch stop layer 316 is deposited above the metal layer 302 and the nano-island pattern 314. As shown in FIG. 3G, the etch stop layer 316 is polished to expose the nano-island pattern 314. The nano-islands 312 and portions of the underlying interlayer dielectric 306 between the metal wires 304 are then etched to create nano-sized holes 318 and air gaps 320 in the metal layer 302, as depicted in FIG. 3H. A layer 322 of interlayer dielectric can be deposited on top of the etch stop layer 316 to cap the nano-sized holes 318 (FIG. 3I).

The pattern of nano-sized holes 318 is designed to create air gaps 320 near the metal wires 304 in the metal layer 302. In turn, the nano-island pattern 314 is designed based on the pattern of nano-sized holes 318 to be formed.

The deposition, photolithography, trimming and etching procedures can be based on conventional CMOS fabrication techniques. Deposition of the thin interlayer dielectric layer 308 can be carried out by a chemical vapor deposition (CVD) process. For example, if the interlayer dielectric is silicon dioxide, the thin layer 308 can be deposited by reacting tetraethylorthosilicate (“TEOS”) and ozone, or by pyrolysing TEOS with or without oxygen. Any other interlayer dielectric material known in the art can be used so long as the dielectric can be etched to create a pattern of nano-islands. In addition, the thin dielectric layer 308 can be deposited in other ways known in the art, such as by plasma-assisted CVD or by wafer spin.

Photolithography is used to produce the patterned photoresist 310, which is then trimmed to produce a pattern of sub-resolution photoresist structures 311 (FIG. 3D). The trimmed photoresist pattern is transferred to the underlying wafer surface. The patterned photoresist is designed based on the desired nano-island pattern. The patterned photoresist structures can be of any shape, including shapes having straight and/or curved surfaces. Any photolithography process used in microchip fabrication can be employed as long as a patterned photoresist that can be trimmed is produced. The term “sub-resolution” refers to structures having critical dimensions less than the resolving power of the particular photolithography system used for patterning the photoresist. For example, if the resolution of the photolithography system is 0.1 μm (the system cannot fabricate features with sizes less than 0.1 μm), then sub-resolution photoresist structures have critical dimensions less than 0.1 μm. In some embodiments, the critical dimension of the trimmed photoresist pattern is less than 100 nm, less than 75 nm, less than 50 nm, less than 25 nm, less than 10 nm, less than 5 nm, or less than 2 nm. In certain embodiments, the critical dimension of the trimmed photoresist pattern is about 100 nm, about 75 nm, about 50 nm, about 25 nm, about 10 nm, about 5 nm, or about 2 nm.

Trimming of the patterned photoresist involves treating the patterned photoresist under conditions suitable to remove sufficient photoresist material to reduce the critical dimension of the patterned photoresist. In particular, trimming involves the removal of material from the lateral and/or top sides of photoresist structures to produce sub-resolution photoresist structures. The particular trimming process employed depends in part on the composition of the photoresist material, the amount of material to be removed, and the location of the material removed (lateral and/or top side). For example, oxygen plasma etching can be used to trim a photoresist material based on carbon and hydrogen.

The trimmed photoresist pattern is transferred to the underlying layer of interlayer dielectric by etching. The particular etching chemistry and method depends in part on the photoresist material, the dielectric material, and the geometry and critical dimensions of the etched dielectric. Although wet etching can be performed, plasma-based dry etching is employed in certain embodiments for transferring submicron geometries. Dry plasma etching can be carried out as a chemical etching process, a physical etching process, or a combined chemical and physical etching process. Either an isotropic or anisotropic etching process can be utilized. Depending on the size and geometry of the desired etched structures, a high-density plasma source may be required. For example, silicon dioxide interlayer dielectric can be etched by applying fluorocarbons such as CF₄ to the wafer surface using a high density plasma etch system.

As a result of etching, the nano-island pattern is produced. As used herein, the term “nano-island” refers to a wafer-supported structure having submicron sizes in at least two of the three spatial dimensions. The nano-islands can be of any shape, including shapes having straight and/or curved surfaces. In some embodiments, the critical dimension of the nano-island pattern is less than 100 nm, less than 75 nm, less than 50 nm, less than 25 nm, less than 10 nm, less than 5 nm or less than 2 nm. In certain embodiments, the critical dimension of the nano-island pattern 314 is about 100 nm, about 75 nm, about 50 nm, about 25 nm, about 10 nm, or about 5 nm.

The particular etch stop layer deposited above the nano-island pattern will depend on the interlayer dielectric used to form the nano-islands, and the etching method to be used to produce the nano-sized holes and air gaps. For example, when the interlayer dielectric is silicon dioxide, an etch stop layer can be silicon carbide or silicon nitride. The etch stop layer can be polished, and the nano-islands exposed, by chemical mechanical planarization (“CMP”). A CMP process which is not selective to the interlayer dielectric and the etch stop layer is preferred.

The polished wafer surface can be wet etched or vapor etched to form the nano-sized holes and the air gaps in the metal layer. The particular etching process will depend on the materials used in forming the nano-islands and the etch stop layer. For example, when the interlayer dielectric is silicon dioxide and the etch stop layer is silicon carbide or silicon nitride, fluorine-based etchants in vapor form can be used for etching. The nano-sized holes can have shapes and dimensions similar to the shapes and dimensions of the nano-islands. In some embodiments, the nano-sized holes 318 have critical dimensions of less than 100 nm, less than 75 nm, less than 50 nm, less than 25 nm, less than 10 nm, less than 5 nm, or less than 2 nm. In certain embodiments, the nano-sized holes 318 have critical dimensions of about 100 nm, about 75 nm, about 50 nm, about 25 nm, about 10 nm, or about 5 nm.

The shapes and dimensions of the air gaps will depend on the particular etching process employed. The etching process can be an isotropic or anisotropic process. Any etching process can be employed that is compatible with the etch stop layer, the dielectric used to form the nano-islands and the metal layer, and the desired shape of the air gaps. For example, when the interlayer dielectric of the metal layer is silicon dioxide, etching can be carried out by F based chemistry such as HF, buffered oxide etchant, etc.

Following air gap formation, the additional layer of dielectric material can be deposited over the polished etch stop layer to cap the nano-sized holes. The dielectric material of the additional layer can be the same as or different from the dielectric material of the interlayer dielectric thin layer.

In accordance with this disclosure, a designed pattern of nano-islands is prepared, which is then used as a guide to create a pattern of nano-sized holes by etching. The nano-sized holes provide access to the interlayer dielectric of a metal layer for etching air gaps near wire interconnects. This can lead to reduced parasitic capacitance in an integrated circuit. The pattern of nano-islands is designed based on the desired pattern of the nano-sized holes, and the pattern of nano-sized holes is designed based on the circuitry of the wire interconnects. Thus, the pattern of nano-islands and the pattern of nano-sized holes can be designed to vary with the circuitry of the underlying metal layer. To prepare the designed nano-island pattern, a photoresist pattern is designed and created based on the desired nano-island pattern.

Although the present disclosure and its advantages have been described in detail, it should be understood that various changes, substitutions and alterations can be made herein without departing from the technology of the disclosure as defined by the appended claims. For example, although the term “above” is used, in this description, as well as the following claims, the orientation can be switched so “below” applies instead. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for creating an air gap pattern for backend of line (BEOL) interconnects, the method comprising:
preparing a designed nano-island pattern; and
etching through the designed nano-island pattern to create at least one air gap.

2. The method of claim 1, wherein preparing the designed nano-island pattern comprises designing the nano-island pattern and creating the designed nano-island pattern in a layer of dielectric material.

3. The method of claim 2, further comprising depositing an etch stop layer above the designed nano-island pattern and polishing the etch stop layer to expose the designed nano-island pattern, prior to etching the at least one air gap.

4. The method of claim 3, further comprising depositing a second dielectric layer above the polished etch stop layer after creating the at least one air gap.

5. The method of claim 2, wherein creating the designed nano-island pattern comprises trimming a patterned photoresist to produce a trimmed photoresist pattern, and transferring the trimmed photoresist pattern to the layer of dielectric material to produce the designed nano-island pattern.

6. The method of claim 5, wherein trimming the patterned photoresist comprises treating the patterned photoresist under conditions suitable to remove sufficient photoresist material to reduce a dimension of the patterned photoresist.

7. A method for creating an air gap pattern for interconnects, the method comprising:
designing a nano-island pattern with photolithography;
preparing the designed nano-island pattern in a layer of dielectric material located above a metal layer, the metal layer comprising the interconnects; and
etching through the designed nano-island pattern to create at least one air gap between the interconnects.

8. The method of claim 7, wherein preparing the designed nano-island pattern comprises:
creating a patterned photoresist;
trimming the patterned photoresist to produce a trimmed photoresist pattern; and
transferring the trimmed photoresist pattern to the layer of dielectric material to produce the designed nano-island pattern.

9. The method of claim 7, further comprising depositing an etch stop layer above the designed nano-island pattern and polishing the etch stop layer to expose the designed nano-island pattern, prior to etching through the designed nano-island pattern.

10. The method of claim 9, further comprising depositing a second dielectric layer above the polished etch stop layer after creating the at least one air gap.

11. A method for creating an air gap pattern for back end of line (BEOL) interconnects, the method comprising:
designing a nano-island pattern;
preparing the designed nano-island pattern in a layer of dielectric material located above a metal layer, the metal layer comprising the back end of line (BEOL) interconnects;
depositing an etch stop layer above the designed nano-island pattern;
polishing the etch stop layer to expose the designed nano-island pattern; and
etching through the designed nano-island pattern to create at least one air gap between the BEOL interconnects.

12. The method of claim 11, further comprising depositing a second dielectric layer above the polished etch stop layer after creating the at least one air gap.

13. The method of claim 11, in which the preparing further comprises depositing the layer of dielectric material on the metal layer.

14. The method of claim 11, in which the designing further comprises patterning a photoresist layer on the layer of dielectric material located above the metal layer.

15. The method of claim 14, further comprising trimming elements of the patterned photoresist layer.

16. The method of claim 14, further comprising etching, via openings in the photoresist layer, the dielectric layer located above the metal layer.

17. The method of claim 16, in which the etching comprises wet etching.

18. The method of claim 16, in which the etching comprises vapor etching.

19. The method of claim 11, in which the polishing comprises chemical mechanical planarization (CMP).
